(19) United States
(12) Patent Application Publication
(10) Pub. No.: US 2014/0309044 A1
(43) Pub. Date: Oct. 16, 2014

(54) LOW-COST POWER TRANSMISSION JOINT WITH A PIVOTING PIN THAT PROVIDES A SECOND PIVOT AXIS

(71) Applicant: TORRANCE DEGUZMAN YAO, EASTVALE, CA (US)

(72) Inventor: TORRANCE DEGUZMAN YAO, EASTVALE, CA (US)

(21) Appl. No.: 14/196,007

(22) Filed: Mar. 4, 2014

Related U.S. Application Data
(60) Provisional application No. 61/811,014, filed on Apr. 11, 2013.

(51) Int. Cl. F16D 3/48

(52) U.S. Cl. CPC F16D 3/48
USPC 464/120

(57) ABSTRACT

Some embodiments include a novel power transmission joint system that is low in cost and can withstand extended wear. The power transmission joint system has several components including a drive cup, a drive shaft pin, and a large contact area between the drive cup and the drive shaft pin. The drive shaft pin is a pivoting pin that provides a second pivot axis to reduce wear on the system. The large contact area is larger than a corresponding contact area of an existing low-cost pinned drive shaft, drive cup system. The large contact area significantly reduces pressure on the system. The power transmission joint system can withstand extended wear and tear.

### CLAIM OF BENEFIT TO PRIOR APPLICATION

This application claims benefit to U.S. Provisional Patent Application 61/811,014, entitled “IMPROVED LOW COST POWER TRANSMISSION JOINT WITH A PIVOTING PIN THAT PROVIDES A SECOND PIVOT AXIS,” filed Apr. 11, 2013. The U.S. Provisional Patent Application 61/811,014 is incorporated herein by reference.

### BACKGROUND

Power transmission joints are designed to transmit rotational power through an angle. In such power transmission joints, a drive shaft must be allowed to pivot in two axes. This is generally easy to accomplish, despite several drawbacks when such transmission joints are used repeatedly. Nevertheless, because of the general ease of producing an enormous power benefit, power transmission joints have been in widespread use for a long time.

Typically, the better the power transmission joint, the more expensive it is. Thus, a range of quality exists among a range of power transmission joint offerings in the market. Many of the most expensive power transmission joints are of a quality that would satisfy most of the consuming public. However, not every customer is willing to pay the price for an expensive power transmission joint. One of the least expensive types is the pinned drive shaft, drive cup system. However, these drive shafts and their corresponding drive cups typically wear out prematurely. Premature wear-down causes several problems with the power drive train. Furthermore, drive train inefficiency is almost always a result of the power transmission joint and drive cup wearing out. Thus, before purchasing a drive train system, a person seeking to save money would need to be aware that existing low-cost power transmission joints wear out quickly and that when the system is worn out, the amount of wear renders the system too inefficient. Regaining efficiency is a difficult and expensive process in which the entire drive shaft system typically must be replaced. Because consumers tend to be interested in maintaining efficiency of most things (including drive shaft/drive cup systems), the frequency of replacing these drive shafts and their corresponding drive cups results in major increases in overall ownership costs, mostly due to the added maintenance costs. This is problematic for consumers who intend to save money by purchasing an inexpensive power transmission joint. In the end, the consumers who take the inexpensive route typically spend more money maintaining a poor system. Therefore, what is needed is a component-based drive train system with a pivoting pin that provides a second pivot axis while simultaneously allowing for a flat contact area with the drive cup in order to reduce the wear and tear that results in inefficiencies of the system.

### BRIEF SUMMARY

Some embodiments of the invention include a novel power transmission joint system that is low in cost and can withstand extended wear. The power transmission joint system of some embodiments comprises a plurality of components including at least a drive cup, a drive shaft pin, and a large contact area between the drive cup and the drive shaft pin. In some embodiments, the drive shaft pin is a pivoting pin that provides a second pivot axis to reduce wear on the system. In some embodiments, the large contact area is larger than a corresponding contact area of an existing low-cost pinned drive shaft, drive cup system. In some embodiments, the large contact area significantly reduces pressure on the system. The power transmission joint system in some embodiments can withstand extended wear and tear. Each component of the power transmission joint system of some embodiments is individually replaceable.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a perspective view of a power transmission joint in some embodiments.

FIG. 2 conceptually illustrates an exploded perspective view of a power transmission joint in some embodiments.

FIG. 3 conceptually illustrates a cross-sectional view of a power transmission joint taken along line 3-3 in FIG. 1.

FIG. 4 conceptually illustrates a cross-sectional view of the power transmission joint illustrated in FIG. 3 with the drive component shown in a rotated position.

FIG. 5 conceptually illustrates a cross-sectional view of a power transmission joint taken along line 5-5 in FIG. 3.

FIG. 6 conceptually illustrates a cross-sectional view of the power transmission joint illustrated in FIG. 5 with the drive component shown in a rotated position.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted to work for a variety of joint systems.

Some embodiments of the invention include a novel power transmission joint system that is low in cost and can withstand extended wear. The power transmission joint system of some embodiments comprises a plurality of components including at least a drive cup, a drive shaft pin, and a large contact area between the drive cup and the drive shaft pin. In some embodiments, the drive shaft pin is a pivoting pin that provides a second pivot axis to reduce wear on the system. In some embodiments, the large contact area is larger than a corresponding contact area of an existing low-cost pinned drive shaft, drive cup system. In some embodiments, the large contact area significantly reduces pressure on the system. The power transmission joint system in some embodiments can withstand extended wear and tear. Each component of the power transmission joint system of some embodiments is individually replaceable.

The power transmission joint system of some embodiments further includes a main drive shaft comprising a set of holes for slide fitting a set of pivoting pins having flattened contact areas and a typical low-cost power transmission joint drive cup. The pivoting pins fit into the holes of the main drive shaft in some embodiments.

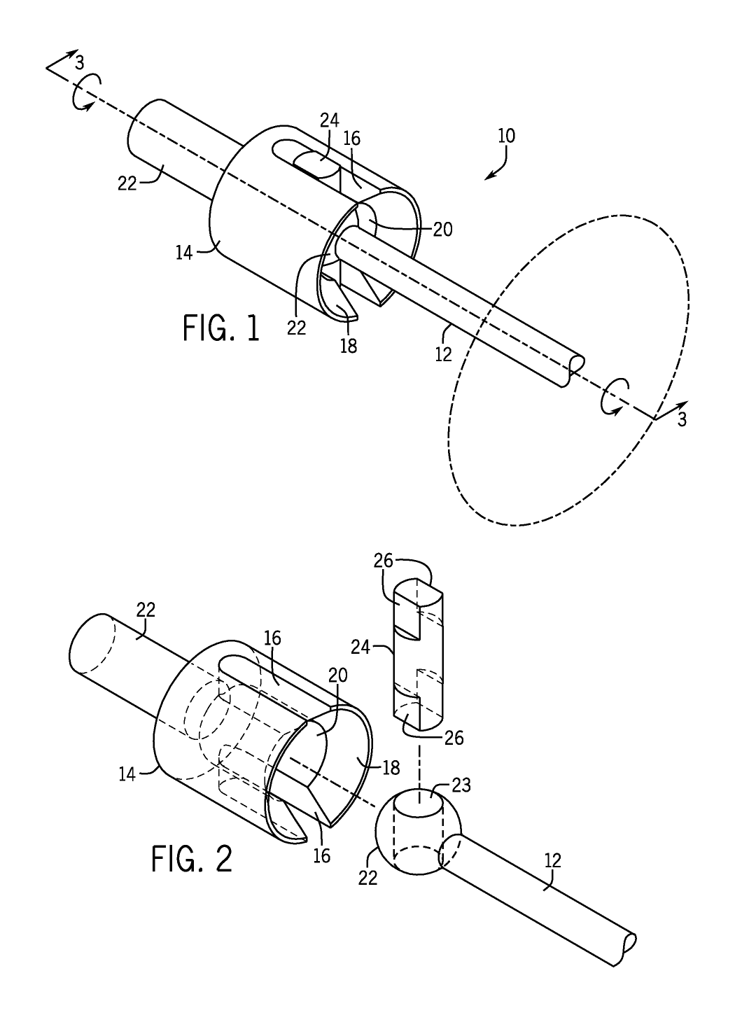

By way of example, FIG. 1 shows a power transmission joint 10 which includes a drive shaft 12 and a drive cup 14. As shown, the drive cup 14 includes a set of drive cup slots 16 and has an conical opening 18. Within the drive cup 14 is a cylindrical bore 20. A ball end 22 of the drive shaft 12 and a pivoting pin 24 fit within the cylindrical bore 20. The drive shaft 12 and pivoting pin 24 assembly slides into the drive cup slots 16 of the drive cup 14. As shown by the circular arrows, the drive shaft 12 can be rotated to transmit power.

Power transmission joints are designed to transmit rotational power through an angle. In some embodiments, the drive shaft 12 of the power transmission joint 10 can pivot in two axes. In some embodiments, this is accomplished by the pivoting pin 24 which provides the second pivot axis while simultaneously providing a flat contact area with the drive cup to reduce wear.

By way of example, FIG. 2 shows an exploded view of the power transmission joint 10 and pivoting pin 24. In particular, the pivoting pin 24 has a set of flat contact areas 26. When assembled, the pivoting pin 24 fits through a bore 23 of the ball end 22 of the drive shaft 12. The flat contact areas 26 of the pivoting pin 24 allow this assembly to rotate around the drive shaft 12. Although this example power transmission joint 10 shown in FIGS. 1 and 2 are applied to one half of the drive shaft 12, in some embodiments, this system can be applied to either one of two half portions of the drive shaft, with the remaining half consisting of any type of existing power transmission joint, such as a universal joint. Alternatively, the system can be applied to both halves of the drive shaft simultaneously.

A typical drive shaft system involves drive shaft pins that slide back and forth within a slot in a drive cup. These existing drive shaft systems include low-cost power transmission joints that rely on a point of contact between the drive shaft and drive cup, through which power is channeled. Because of its very small surface area, this contact point yields immense pressure. The immense pressure then accelerates wear on the drive cup as the drive shaft's pin slides back along the slot on the drive cup. In some embodiments, the pivoting pin 24 allows the flat contact areas 26 to be the contacts between the drive shaft 12 and the drive cup 14. As a result, the wear and tear on the system is reduced. Additionally, in some embodiments the contact areas 26 provide for an overall larger contact surface area between the drive shaft pin 24 and drive cup 14, and therefore, reduces wear. Accordingly, the power transmission joint 10 of some embodiments improves upon existing systems because providing a larger contact area between the drive cup and drive shaft pin significantly reduces the pressure and thus extending wear of the system.

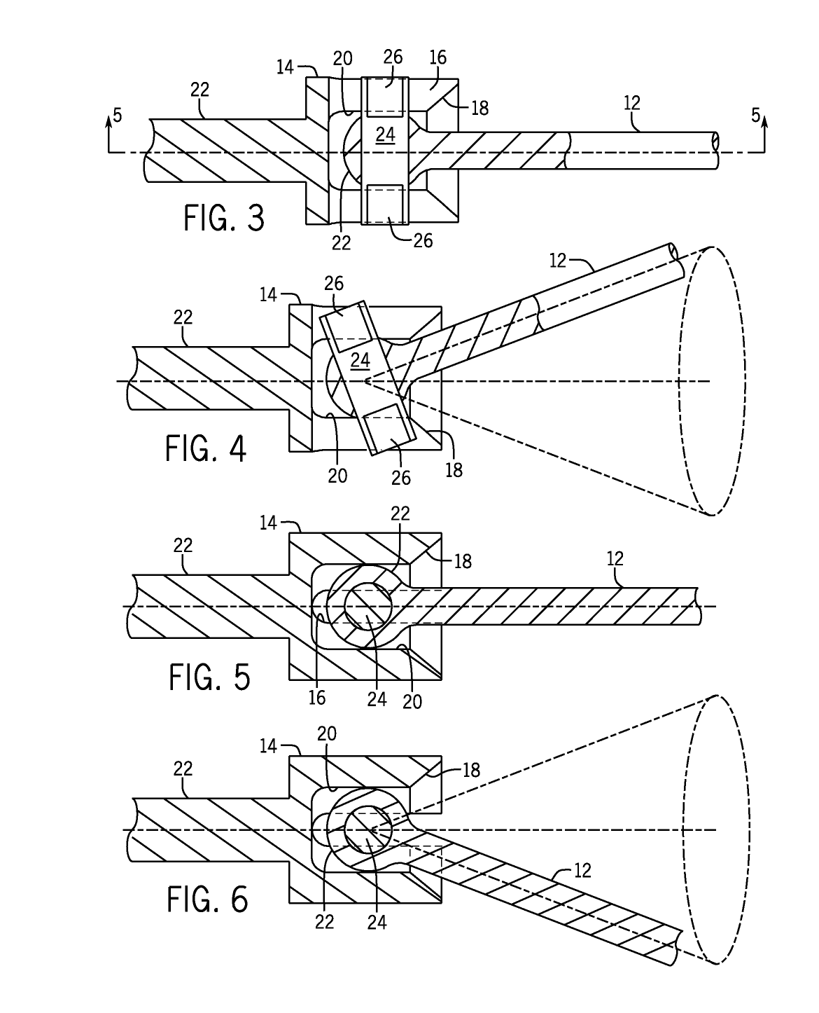

In another aspect of the power transmission joint 10, in some embodiments, the pivoting pin 24 provides a second pivot axis for the drive shaft 12. By way of example, FIGS. 3-6 illustrate how the drive shaft 12 is able to pivot along a first axis and a second axis, thereby defining a range of movement along two axes. In particular, FIG. 3 shows the power transmission joint taken along line 3-3 in FIG. 1. In this view, the pivoting pin 24 fits in the drive cup 14 with the flat contact areas 26 slid in between the edges of the drive cup slots 16. The non-flat portion of the pivoting pin 24 fits within the cylindrical bore 20.

In FIG. 4, which shows an example of the drive shaft 12 in a rotated position, the pivoting pin 24 has moved to a point at which the drive shaft 12 comes into contact with the top opening of the conical opening 18. As illustrated by the dashed lines of this figure, the drive shaft 12 can be moved down to the bottom of the conical opening 18. Thus, a range of top-to-bottom movement is shown along this axis.

Next, FIG. 5 shows the power transmission joint taken along line 5-5 in FIG. 3. In this example, the pivoting pin 24 is shown from the top of the power transmission joint 10 looking down (or alternatively, from the bottom looking up). In FIG. 6, the drive shaft 12 is shown in a rotated position. Specifically, the drive shaft 12 has moved along the second axis to one side of the conical opening 18. The dashed lines conceptually illustrate the range of movement of the drive shaft 12 along the second axis.

While all elements are necessary for this system to work, implementation is elementary. Simply insert the pivoting pins into the holes in the drive shaft and then slide this shaft/pin assembly into the drive cup with the flat areas on the pin aligned with the slot in the drive cup. Additionally, using lubricant on the pins can increase performance and longevity. Overall, the range of movement of the drive shaft 12 is shown by the circular dashed line in FIGS. 1, 4, and 6.

In addition, when the time comes to refresh or rebuild the system, the user only needs to replace the relatively inexpensive worn out components instead of the entire system. Thus, in addition to reducing the cost of maintaining a power transmission joint and extending the life of a power transmission joint's components compared to existing systems, this invention will also have lower maintenance costs because the disposable parts that need to be replaced are limited to the pin and drive cup only. All other components can be reused. Thus, the power transmission joint of these embodiments provides a low-cost and long-life alternative to existing systems.

The above-described embodiments of the invention are presented for purposes of illustration and not of limitation. While the invention has been described with reference to numerous specific details, one of ordinary skill in the art will recognize that the invention can be embodied in other specific forms without departing from the spirit of the invention. Some embodiments of the power transmission joint can be installed in applications where rotational power must be transmitted through an angle, for example through universal joints or constant velocity joints, including (i) power drive trains for cars, trucks, and other automotive vehicles, (ii) tools which need to transmit rotational torque at one or more angles, and (iii) motorized toys that require power transmission from a motor. Thus, one of ordinary skill in the art would understand that the invention is not to be limited by the foregoing illustrative details, but rather is to be defined by the appended claims.

I claim:

1. A power transmission joint system that pivots along multiple axes comprising:
a main drive shaft comprising a bore to slip fit a pivoting pin;
a pivoting pin that fits within the bore of the main drive shaft and pivots the power transmission joint along at least two axes; and
a low-cost power transmission joint drive cup comprising a set of slots, wherein the main drive shaft and pivoting pin, when assembled together, slide into the slots.

2. The power transmission joint system of claim 1, wherein the pivoting pin comprises a set of flattened contact areas.

3. The power transmission joint system of claim 2, wherein the set of flattened contact areas fit within the slots.

4. The power transmission joint system of claim 2, wherein the set of flattened contact areas comprises four flattened contact areas.

5. The power transmission joint system of claim 4, wherein the set of slots comprises two slots of the drive cup, wherein two of the flattened contact areas fit within a first slot and the other two flattened contact areas fit within a second slot.

6. The power transmission joint system of claim 1, wherein the drive shaft comprises drive shaft ball end that allows the drive shaft to rotate along two axes.

7. The power transmission joint system of claim 6, wherein the bore of the main drive shaft is within the drive shaft ball end.

8. The power transmission joint system of claim 6, wherein the main drive shaft moves up and down along a first axis.

9. The power transmission joint system of claim 6, wherein the main drive shaft moves left and right along a second axis.

10. The power transmission joint system of claim 1 further comprising a universal joint.
